(19) United States
(12) Patent Application Publication
(10) Pub. No.: US 2007/0233494 A1
(43) Pub. Date: Oct. 4, 2007

(54) METHOD AND SYSTEM FOR GENERATING SOUND EFFECTS INTERACTIVELY

(75) Inventors: Liqin Shen, Beijing (CN); Hai Ping Li, Beijing (CN); Qin Shi, Beijing (CN); Zhiwei Shuang, Beijing (CN)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK, NY (US)

(21) Appl. No.: 11/691,511

(22) Filed: Mar. 27, 2007

(30) Foreign Application Priority Data
Mar. 28, 2006 (CN) 200610066503.4

(51) Int. Cl. G10L 13/08

(52) U.S. Cl. 704/260

(57) ABSTRACT

The invention provides a method and system for generating sound effects interactively. The method provides a plurality of sound effect tags to a user, wherein each of the plurality of sound effects corresponds to a specific sound effect object. The sound effect object includes a seed sound representing a predefined audio file and a sound effect action representing an operation on sound. Then the user selects at least one of the sound effect tags for a whole source sound or at least a piece of the source sound. The method edits the source sound by using the selected sound effect tags to form a sound effect expression, interprets the sound effect expression to determine the operations corresponding to respective sound effect tags in the sound effect expression and the execution order of the operations, and executes the operations in said order to output a sound with the sound effects. The method of the invention enables a user to perform sound effect editing on sound in real time and dynamically, thus providing more customized sound effects.

### FIELD OF THE INVENTION

The present invention relates to the field of sound processing, and in particular to a method and system for generating sound effects interactively.

### BACKGROUND OF THE INVENTION

Along with the development of multimedia technology, more and more users are beginning to use sound effects to make many applications more animate and interesting. For example, a user would select some favorite music from an incidental music list to add to an electronic greeting card. In some email software, a user can select a piece of background music from a predefined background music list. With the wide use of voice technology in multimedia communications, users also hope to be able to realize special sound effects on pre-recorded sound or synthesized voice/audio by themselves in order to achieve customized sound effects. For example, in online games, users would like to change the voice according to different roles. In multimedia short message communications, users want to realize various sound effects on the short messages to make them more attractive. In real-time chatting, users may want to create some special chatting environments, such as at a seaside or in a cave.

In the prior art, most multimedia applications only provide simple predefined sound effect options, whereby the sound effects are inserted into text information. When a text-to-speech conversion is performed for the text information, the corresponding audio files are invoked according to the inserted sound effects, and then the text information is played to the user in audio form. For example, U.S. Patent Application Publication No. 2002/0193996, “Audio-form Presentation of Text Messages” and U.S. Pat. No. 6,963,839, “System and Method of Controlling Sound in a Multi-Media Communication Application” both provide such a technical solution. However, in these technical solutions, sound effect actions and the objects thereof (audio files) are not separated. Therefore, the sound effects cannot be further edited, and the sound effects after such a sound effect processing are unchanged.

Additionally, some professional audio editing software can provide powerful sound effect editing functions, but the software is too complicated for an end user. The audio editing software is typically an individual off-line system, which cannot be used by the user in a real-time system.

### SUMMARY OF THE INVENTION

The present invention is proposed in view of the above technical problems, the objective of which is to provide a method and system for generating sound effects interactively, which can provide flexible sound effect tags, and can combine the sound effect tags in various ways to generate sound effect expression, thus facilitating the sound effect editing by a user, and can be combined with multimedia real-time systems such as online games, real-time chatting, and the like conveniently, and can be used in various application scenarios.

According to an aspect of the present invention, there is provided a method for generating sound effects interactively, comprising the steps of providing a plurality of sound effect tags to a user, wherein each of the plurality of sound effect tags corresponds to a specific sound effect object, the sound effect object includes a seed sound representing a predefined audio file and a sound effect action representing an operation on sound, selecting at least one of the plurality of sound effect tags for a whole source sound or at least a piece of the source sound by the user; editing the source sound by using the selected sound effect tags to form a sound effect expression, interpreting the sound effect expression to determine the operations corresponding to respective sound effect tags in the sound effect expression and the execution order of the operations, and executing the operations in said order to output a sound with the sound effects.

Preferably, the sound effect tags comprise system-predefined sound effect tags.

Preferably, the sound effect tags further comprise user-defined sound effect tags.

Preferably, the sound effect tags are provided to the user in the form of textual tags and/or icons, and the icons have the corresponding textual tags

Preferably, the sound effect tags are classified by type or sorted by frequency of use.

Preferably, the sound effect action comprise an inserting operation, a mixing operation, an echoing operation and a distorting operation; wherein, the inserting operation is an operation of inserting a piece of sound into another piece of sound, the mixing operation is an operation of mixing a piece of sound with another piece of sound, the echoing operation is an operation of making a piece of sound echo, and the distorting operation is an operation of distorting a piece of sound.

Preferably, the source sound is any one of a prerecorded sound, a real-time sound or a sound synthesized by text-to-speech.

Preferably, the sound effect expression is in XML format.

Preferably, the sound effect expression is in text form.

Preferably, the sound effect expression is in the form of the combination of text and icon.

Preferably, the sound effect expression is interpreted with an XML interpreter.

Preferably, the sound effect expression is interpreted with a standard stack-based rule interpretation method.

Preferably, the step of interpreting the sound effect expression comprises translating the icons in the sound effect expression into the corresponding textual tags, and interpreting the sound effect expression with a standard stack-based rule interpretation method.

Preferably, to determine the operations corresponding to respective sound effect tags comprises to determine the sound effect objects corresponding to respective sound effect tags, and further to determine the operations on respective seed sounds and the sound objects on which respective sound effect actions are operated.

According to another aspect of the present invention, there is provided a system for generating sound effects interactively, comprising a sound effect tag provider for providing a plurality of sound effect tags to a user, wherein each of the plurality of sound effect tags corresponds to a specific sound effect object, the sound effect object includes a seed sound representing a predefined audio file and a sound effect action representing an operation on sound, a sound effect tag selector for selecting at least one of the plurality of sound effect tags for a whole source sound or at least a piece of the source sound by the user, a sound effect editor for editing the source sound by using the selected sound effect tags to form a sound effect expression, a sound effect interpreter for interpreting the sound effect expression to determine the operations corresponding to respective sound effect tags in the sound effect expression and the execution order of the operations, and a sound effect engine for executing the operations in said order to output a sound with the sound effects.

Preferably, the system for generating sound effects interactively further comprises a sound effect tag generator for linking a specific tag with a specific sound effect object to form a sound effect tag.

Preferably, the sound effect tag generator further comprises a sound effect tag setting interface for defining the sound effect tags by the user.

Preferably, the sound effect tag provider further comprises a sound effect tag library for storing system-predefined sound effect tags and/or user-defined sound effect tags.

Preferably, the sound effect engine comprises an inserting module for performing the inserting operation, a mixing module for performing the mixing operation, an echoing module for performing the echoing operation, and a distorting module for performing the distorting operation.

### BRIEF DESCRIPTION OF THE DRAWINGS

FIG. 1 is a flowchart of a method for generating sound effects interactively according to an embodiment of the present invention; and

FIG. 2 is a schematic block diagram of a system for generating sound effects interactively according to an embodiment of the present invention.

### DETAILED DESCRIPTION OF EMBODIMENTS OF THE INVENTION

It is believed that the above and other objectives, features and advantages of the present invention will become more apparent by referring to the detailed description of particular embodiments of the present invention in conjunction with the drawings.

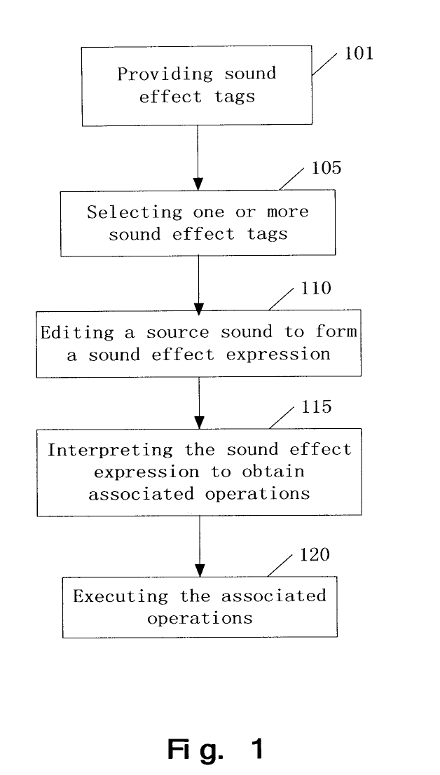

FIG. 1 is a flowchart of a method for generating sound effects interactively according to an embodiment of the present invention. As shown in FIG. 1, in step 101, a plurality of sound effect tags are provided to a user. In the present invention, each sound effect tag corresponds to a specific sound effect object. The sound effect object includes a seed sound representing a predefined audio file and a sound effect action representing an operation on sound. Generally, the sound effect tag is generated by linking a specific sound effect object with a specific tag. The sound effect tags can be system-predefined or user-defined. In the present embodiment, it is proposed to provide a system-predefined sound effect tag library containing commonly used sound effect tags before allowing a user to define sound effect tags on his own. In this way, the user can add new sound effect tags to the sound effect tag library or modify the sound effect tags in the sound effect tag library, rather than rebuilding the sound effect tag library from scratch.

The sound effect objects in the sound effect tags will now be described below in detail.

As described above, the sound effect objects include the seed sounds and the sound effect actions.

The seed sound is a predefined audio file, which can be various kinds of audio files, such as music, wind sound, animal sound, a clap, a laughter and the like. That is to say, the seed sound is the sound which is prepared before the user performs sound effect editing.

The sound effect action is an operation on sound, including an inserting operation, a mixing operation, an echoing operation and a distorting operation. The inserting operation is to insert a piece of sound into another piece of sound. For example, the clap and the laughter can be inserted into a piece of speech in order to achieve the effect of animating the atmosphere. The mixing operation is to mix a piece of sound with another piece of sound. For example, the sound of reciting a text can be mixed with a piece of music in order to achieve a lyric effect. The echoing operation is to make a piece of sound echo, for example, simulating speaking in a valley or an empty room. The distorting operation is to distort a piece of sound in order to achieve special expressiveness. For example, the male voice can be changed to the female voice, and someone's voice can be distorted to sound like a cartoon figure. It will be apparent to those skilled in the art that the sound effect actions can also include other operations apart from the above inserting operation, mixing operation, echoing operation and distorting operation.

Consequently, the sound effect tags can include sound tags and action tags. In an embodiment of the present invention, such sound effect tags can be provided to the user in the form of textual tags and/or icons. The icons have their corresponding textual tags. For example, an icon of an animal can represent the seed sound as the sound of the animal. The textual tag corresponding to the icon is the name of the animal. The textual tag “MIX” can represent the mixing operation. In general, there is an obvious association between a sound effect tag and a sound effect object to facilitate the user.

Further, the sound effect tags can be stored in a sound effect tag library. In this library, the specific tags can be stored in a tag list. The seed sounds can be in the form of audio files. The sound effect actions can be embodied in the form of applications. There is a link between each tag and the corresponding sound effect object.

Although in the present embodiment only the approach where the sound effect tags are stored in the sound effect tag library is provided, those skilled in the art will readily appreciate that other approaches can be employed to store the sound effect tags.

In the sound effect tag library, the sound tags and the action tags can be organized separately to facilitate their use by the user. The organization method of the sound tags and the action tags will be described below by way of example.

1. Sound Tags

In this embodiment, there are provided two organization methods of the sound tags.

1) Classifying by type. For example, the sound tags can be classified into music type, nature type, human voice type, and others. The music type can be further classified into classic music, modern music, rock and roll, popular music, and terror music The nature type can be further classified into natural sound such as wind sound, rain sound, sea wave sound and the like and animal sound such as sound of a bird, sound of a frog and the like. The human voice type can be further classified into greetings and classic lines. The others type can be further classified into laughter, cry and terrified shriek.

Although only one method of classification has been presented here, those skilled in the art will appreciate that other methods of classification can be employed.

2) Sorting by frequency of use. This organization method is to arrange the sound tags in the descending order of the frequency of use based on the statistics on the frequency of use. Generally, the sound tags are sorted initially based on pre-configured frequencies of use. With the use by the user, the frequency of use of each sound tag changes. Then the order of the sound tags will be changed according to the new frequency of use, thus being able to adjust the order of the sound tags dynamically.

Although the two organization methods of the sound tags have been presented above, it should be noted that other organization methods can also be used to organize the sound tags.

2. Action Tags

In this embodiment, there are also provided two organization methods of the action tags similar to those of the sound tags.

1) Classifying by type. This organization method is to classify the action tags by the type of the sound effect action. Therefore, the action tags can be classified into an inserting operation type, a mixing operation type, an echoing operation type and a distorting operation type. For example, the mixing operation type can be further classified into strong background sound and weak background sound operation. The echoing operation type can be further classified into echoing in an empty room echo, echoing in a valley, echoing in a cave and the like. The distorting operation type can be further classified into changing from the male voice to the female voice, from the female voice to the male voice, from the voice of the old to the young, from the voice of the young to the old, from the human voice to the sound of a robot, from the human voice to the sound of a ghost, and from the human voice to the sound of a wizard and the like.

2) Sorting by frequency of use. This method is to arrange the action tags in the descending order of the frequency of use based on the statistics on the frequency of use. Generally, the action tags are sorted initially based on pre-configured frequencies of use. With the use by the user, the frequency of use of each action tag changes. Then the order of the action tags will be changed according to the new frequency of use, thus being able to adjust the order of the action tags dynamically.

Although the two organization methods of the action tags have been presented above, it should be appreciated that other organization methods can also be used to organize the action tags.

It should be noted that, as described above, these sound effect tags (including the seed sound tags and the sound effect action tags) can be either system-predefined or user-defined.

Now returning to FIG. 1, in step 105, the user selects one or more sound effect tags for a whole source sound or one or more pieces of the source sound. The source sound is the sound on which the user intends to perform sound effect editing. The source sound can be a pre-recorded sound or a real-time sound entered by the user. Alternatively, the user can also enter text, and the text is converted into voice by a text-to-speech operation as the source sound.

For example, if the user intends to perform sound effect editing on the text “You will get your deserts”, he needs to invoke the text-to-speech operation to convert the text into voice as the source sound. Then the user selects the “echoing in an empty room” action tag, the “wind sound” sound tag, and the “mixing” action tag one by one for the source sound.

Then, in step 110, the source sound is edited by using the selected sound effect tags to form a sound effect expression of the source sound. Particularly, for the whole source sound or one or more pieces of the source sound, the one or more sound effect tags selected by the user are combined with the corresponding source sounds, thus forming the sound effect expression of the source sounds. In the above example, editing the source sound is to combine the synthesized voice “You will get your deserts” with the “echoing in an empty room” action tag, and then combine with the “sound wind” sound tag via the “mixing” action tag, thus producing the sound effect expression.

The sound effect expression can be in various forms. In the present embodiment, the following forms of the sound effect expression are provided.

Firstly, the sound effect expression can be in XML format. In this case, the above-mentioned editing process of sound effects is described in the XML language, wherein the sound effect tags are indicated by their corresponding specific textual tags. Even if the selected sound effect tags are provided to the user in the form of icons, the icons should be converted into the corresponding textual tags when forming the sound effect expression. In the above example, the sound effect expression of the source sound is as follows:

```
<Operation -mix>
  <seed> wind <\seed>
  <Operation -echo_room>
    <TTS>
    You will get your deserts
    <\TTS>
  <\Operation>
<\Operation>
```

This piece of XML language describes the editing process of sound effects required by the user. That is, the text-to-speech (TTS) operation is performed on the text “You will get your deserts” to produce the source sound. Then the source sound is edited by the “echoing in an empty room” operation (Operation—echo_room), and then “mixed” (Operation—mix) with the “wind sound”(seed sound “wind”).

The sound effect expression can also be represented in text form. In this case, the sound effect tags are also indicated by their corresponding specific textual tags. Even if the selected sound effects are provided to the user in the form of icons, the icons should be converted into the corresponding textual tags when forming the sound effect expression. In the above example, the sound effect expression of the source sound is as follows:

MIX(WIND, ECHOROOM(TTS(You will get your deserts)))

Similarly, this sound effect expression in text form also describes the editing process of sound effects required by the user. That is, the text-to-speech (TTS) operation is performed on the text “You will get your deserts” to produce the source sound. Then the source sound is edited by the “echoing in an empty room” operation (ECHOROOM), and then mixed (MIX) with the “wind sound” (seed sound WIND). The executing order of above sound effect actions is defined by brackets in the above sound effect expression in text form, which is in the way like mathematical expressions.

Furthermore, the sound effect expression can also be represented in the form of the combination of text and icon. In the above example, the sound effect expression of the source sound is as follows:

[symbol]

+ [symbol] ( [symbol] You will get your desert)

wherein all the sound effect tags are indicated by icons.

In the above sound effect expression, the editing process of sound effects required by the user is described with the icons. That is, the text-to-speech operation ( [symbol] ) is performed on the text “You will get your deserts” to produce the source sound. Then the source sound is edited by the “echoing in an empty room” operation ( [symbol] ), and then “mixed” (+) with the “wind sound” ( [symbol] ).

Of course, those skilled in the art will appreciate that other forms of the sound effect expression can also be used.

Next, in step 115, the sound effect expression of the source sound formed in step 110 is interpreted in order to determine the operations corresponding to respective sound effect tags in the sound effect expression and the execution order of these operations. In this step, to determine the operations corresponding to respective sound effect tags in the sound effect expression comprises: to determine the sound effect objects corresponding to respective sound effect tags, to determine the operations on respective seed sounds and to determine the sound objects on which respective sound effect actions are operated.

For different forms of the sound effect expression, the corresponding interpretation methods are used.

For a sound effect expression in XML format, an XML interpreter is used for interpreting. For the XML interpreter, the related information can be obtained from http://www.w3.org/TR/REC-xml/, and it will not be described here in detail.

For a sound effect expression in text form, a standard stack-based rule interpretation method is used for interpreting. This rule interpretation method is well-known to those skilled in the art and will not be described here in detail.

For a sound effect expression in the form of the combination of text and icon, when the expression is interpreted, the icons in the sound effect expression need to be translated into their corresponding textual tags. Then the standard stack-based rule interpretation method is used for interpreting.

In the above example, after the interpretation of the sound effect expression, the associated operations and the operation order are obtained as follows: firstly, the “echoing in an empty room” operation is performed, the sound object of which is the synthesized voice “You will get your deserts”; secondly, the “mixing” operation is performed, the sound objects of which are the synthesized voice “You will get your deserts” with the empty room echo effect and the wind sound.

In step 120, the associated operations are performed in the operation order obtained in step 115 to output a sound with the sound effects. In the above example, the application of the “echoing in an empty room” operation is invoked to make the synthesized voice “You will get your deserts” have the echo effect. Then the audio file of the wind sound is obtained and the application of the “mixing” operation is invoked in order to mix the synthesized voice with the echo effect with the wind sound to produce the final sound effects.

From the above description it can be seen that the method for generating sound effects interactively according to the present invention can provide sound tags and action tags separately, thus overcoming the drawback in the prior art that a sound effect action cannot be separated from the object (audio file) of the sound effect action, making the sound effect tags more flexible. In the present invention, the sound effect tags can be further combined to form the sound effect expression, thus facilitating the user to edit the sound effects in real-time and dynamically, so as to provide more customized sound effects.

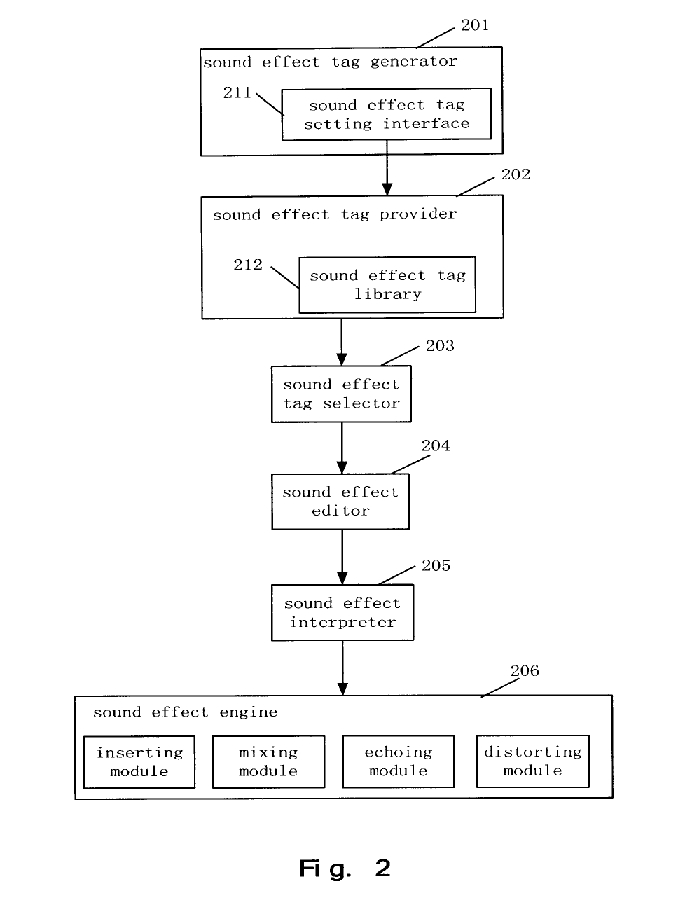

Under the same inventive concept, FIG. 2 is a schematic block diagram of a system for generating sound effects interactively according to an embodiment of the present invention. The embodiment of the present invention will be described below in detail with reference to the drawing.

As shown in FIG. 2, the system for generating sound effects interactively comprises: a sound effect tag generator 201 for generating a sound effect tag by linking a specific sound effect object with a specific tag, wherein the sound effect objects include seed sounds each representing a predefined audio file and sound effect actions each representing an operation on sound, as described above; a sound effect tag provider 202 for providing a plurality of sound effect tags to a user; a sound effect tag selector 203 by which the user selects one or more sound effect tags for a whole source sound or one or more pieces of the source sound; a sound effect editor 204 for editing the source sound by using the selected sound effect tags to form a sound effect expression of the source sound; a sound effect interpreter 205 for interpreting the sound effect expression to determine the operations associated with respective sound effect tags in the sound effect expression and the execution order of the operations; and a sound effect engine 206 for executing the operations according to said order to output a sound with the sound effects.

The various components of the system for generating sound effects interactively will further be described below in detail.

As shown in the FIG. 2, in this embodiment, the sound effect tag provider 202 comprises a sound effect tag library 212 for storing the sound effect tags. In the sound effect tag library 212, the sound tags and the action tags can be organized separately, and the organization method of classifying by type or sorting by frequency of use can be employed. The organization method of the sound effect tags has been described above in detail, and will not be repeated here. Additionally, since the above sound effect tags can be either system-predefined or user-defined, the system-predefined sound effect tags and user-defined sound effect tags can be organized separately in the sound effect tag library 212. That is, the sound effect tag library 212 can comprise a predefined sound effect tag library and a user-defined sound effect tag library.

As described above, the sound effect tag generator 201 is used to generate the sound effect tag by linking the specific sound effect object with the specific tag. The various sound effect objects in sound effect tags have been described above in detail and will not be repeated here. The sound effect tags can include the sound tags and the action tags with respect to different sound effect objects.

Further, the sound effect tag generator 201 further comprises a sound effect tag setting interface 211 for defining the sound effect tag by the user. Since the setting methods for the seed sound tag and the sound effect action tag differ considerably, in the present embodiment, there are provided two different sound effect tag setting interfaces for the sound tag setting and the action tag setting respectively.

The sound tag setting interface and the action tag setting interface will be described below with respect to different organization methods of the sound effect tags.

Now the sound tag setting interface will be described. In the case where the sound tags are sorted by the frequency of use.

The user selects to create a seed sound tag.

The system pops up a dialog, requesting the user to specify: 1. an audio file; 2. a corresponding tag.

The user clicks “OK” after completing the input.

The sound tag is added to the user-defined tag library in the sound effect tag library.

The user can see the added tag at the end of the user-defined tag list of the icon list.

In the case where the sound tags are organized by classification,

The user selects to create a seed sound tag.

The system pops up a dialog, requesting the user to specify: 1. an audio file; 2. a corresponding tag; 3. a classification.

The user clicks “OK” after completing the input, and the sound tag is added to the user-defined tag library in the sound effect tag library.

The user can see the added tag at the end of the user-defined tag list corresponding to the specified classification.

Next, the sound effect action tag setting interface will be described. Since the sound effect action tags are generally organized by classification, the sound effect action tag setting interface will be described with respect to the sound effect action tags organized by classification.

The user selects to create a sound effect action tag.

The system pops up a dialog, requesting the user to specify: 1. a classification to which the sound effect action belongs.

The user selects the classification and the system pops up a parameter dialog corresponding to the specified classification, requesting the user to specify: 2. particular action parameter settings.

After the user completes the parameter settings, the system requests the user to specify: 3. a corresponding tag.

The user clicks “OK” after completing the input, and the sound effect action tag is added to the user-defined tag library in the sound effect action library.

The user can see the added tag at the end of the user-defined tag list corresponding to the specified classification.

The sound effect tag generator 201 in the system for generating sound effects interactively according to a preferred embodiment of the present invention has been described above. Next, other components in the system for generating sound effects interactively will be described in detail.

When the user needs to perform sound effect editing, he first inputs the source sound to the sound effect tag selector 203, in which the user selects one or more sound effect tags for the whole source sound or one or more pieces of the source sound according to his preference.

The source sound can be a pre-recorded sound or a real-time sound. In addition, when the user inputs a text, the text needs to be converted into voice by the text-to-speech operation. Then this synthesized voice is input to the sound effect tag selector 203 as the source sound.

For example, when the user intends to perform sound effect editing on the text “You will get your deserts”, the text-to-speech operation is invoked to convert the text into voice as the source sound. Then for the source sound, the user selects the “echoing in an empty room” action tag, the “wind sound” sound tag and the “mixing” action tag one by one from the sound effect tag library 212 through the sound effect tag list.

After the user has selected the sound effect tags, these sound effect tags and their corresponding source sounds are output to the sound effect editor 204. In the above example, the “echoing in an empty room” action tag, the “wind sound” sound tag, the “mixing” action tag and the synthesized voice “You will get your deserts” are input to the sound effect editor 204.

In the sound effect editor 204, for the whole source sound or one or more pieces of the source sound, the selected one or more sound effect tags are combined with the corresponding source sounds to form the sound effect expressions of the source sounds. In the above example, the synthesized voice “You will get your deserts” is combined with the “echoing in an empty room” action tag, and then combined with the “wind sound” sound tag via the “mixing” action tag, thus producing the sound effect expression.

Further, the sound effect editor 204 can be an XML editor, by which the sound effect expression in XML format can be formed. In the above example, the sound effect expression of the source sound is as follows:

```
<Operation -mix>
  <seed> wind <\seed>
  <Operation -echo_room>
    <TTS>
    You will get your deserts
    <\TTS>
  <\Operation>
<\Operation>
```

The sound effect editor 204 can also be a text editor, by which the sound effect expression in text form can be formed. In the above example, the sound effect expression of the source sound is as follows:

MIX(WIND, ECHOROOM(TTS(You will get your deserts))).

Moreover, the sound effect editor 204 can also be an editor that can edit both text and icon, by which the sound effect expression with the combination of text and icon can be formed. In the above example, the sound effect expression of the source sound is as follows:

[symbol]

+ [symbol] ( [symbol] You will get your deserts)

Of course, those skilled in the art will appreciate that other editors can also be used as the sound effect editor.

After the sound effect expression of the source sound has been formed in the sound effect editor 204, the sound effect expression is output to the sound effect interpreter 205. Since the forming methods of the sound effect expression are different, the sound effect interpreter 205 needs to use the corresponding interpreter. The sound effect interpreter 205 can determine the operations corresponding to respective sound effect tags and the execution order of the these operations by interpreting the sound effect expression, wherein determining the operations corresponding to respective sound effect tags comprises: determining the sound effect contents of respective sound effect tags, and further determining the operations on respective seed sounds and the sound objects on which respective sound effect actions are operated.

For a sound effect expression in XML format, the sound effect interpreter 205 is an XML interpreter, which can interpret the sound effect expression in XML format. The related information of the XML interpreter can be obtained from http://www.w3.org/TR/REC-xml/, and it will not be described here in detail.

For a sound effect expression in text form, the sound effect interpreter 205 uses a standard stack-based rule interpretation method to interpret the expression. This rule interpretation method is well-known to those skilled in the art and will not be described here in detail.

For a sound effect expression with the combination of text and icon, the sound effect interpreter 205 translates the icons in the sound effect expression into their corresponding textual tags, and then uses the standard stack-based rule interpretation method to interpret it.

In the above example, through the interpretation of the sound effect interpreter 205, the associated operations of this sound effect expression and the operation order are as follows: firstly, the “echoing in an empty room” operation is performed, the sound object of which is the synthesized voice “You will get your deserts”; secondly, the “mixing” operation is performed, the sound objects of which are the synthesized voice “You will get your deserts” with the empty room echo effect and the wind sound.

The operations and the operation order associated with the sound effect expression are input to the sound effect engine 206, which performs the associated operations according to the above order.

Further, the sound effect engine 206 comprises: an inserting module for performing the inserting operation, namely the operation of inserting a piece of sound into another piece of sound; a mixing module for performing the mixing operation, namely the operation of mixing one piece of sound with another piece of sound; an echoing module for performing the echoing operation, namely the operation of making a piece of sound echo; and a distorting module for performing the distorting operation, namely the operation of distorting a piece of sound.

In the above example, the synthesized voice “You will get your deserts” is first input to the echoing module, which outputs the synthesized voice with the echo effect. Then the synthesized voice with the echo effect and the audio file of wind sound are input to the mixing module, and finally the sound with the final sound effects are output from the mixing module.

From the above description it can be seen that using the system for generating sound effect interactively of the present embodiment can provide the sound tags and the action tags separately to the user, thus overcoming the drawback in the prior art that the sound effect actions and their objects (audio files) cannot be separated, and making sound effect tags more flexible. In the present invention, by further combining the sound effect tags, the sound effect expression can be formed, thus facilitating the user to edit sound effects in real-time and dynamically, so as to provide the more customized sound effects.

Although the method and system for generating sound effects interactively of the present invention have been described above with reference to the embodiment, it should be noted that those skilled in the art can make various modifications to the above embodiment without departing from the scope and spirit of the present invention.

What is claimed:

1. A method for generating sound effects interactively, comprising the steps of:
providing a plurality of sound effect tags to a user, wherein each of the plurality of sound effect tags corresponds to a specific sound effect object, the sound effect object includes a seed sound representing a predefined audio file and a sound effect action representing an operation on sound;
selecting at least one of the plurality of sound effect tags for a whole source sound or at least a piece of the source sound by the user;
editing the source sound by using the selected sound effect tags to form a sound effect expression;
interpreting the sound effect expression to determine the operations corresponding to respective sound effect tags in the sound effect expression and the execution order of the operations; and
executing the operations in said order to output a sound with the sound effects.

2. The method according to claim 1, wherein the sound effect tags comprise system-predefined sound effect tags.

3. The method according to claim 2, wherein the sound effect tags further comprise user-defined sound effect tags.

4. The method according to claim 1, wherein the sound effect tags are provided to the user in the form of textual tags and/or icons, and the icons have the corresponding textual tags.

5. The method according to claim 1, wherein the sound effect tags are classified by type or sorted by frequency of use.

6. The method according to claim 1, wherein the sound effect action comprises an inserting operation, a mixing operation, an echoing operation and a distorting operation; wherein,
the inserting operation is an operation of inserting a piece of sound into another piece of sound;
the mixing operation is an operation of mixing a piece of sound with another piece of sound;
the echoing operation is an operation of making a piece of sound echo; and
the distorting operation is an operation of distorting a piece of sound.

7. The method according to claim 1, wherein the source sound is any one of a prerecorded sound, a real-time sound or a sound synthesized by text-to-speech.

8. The method according to claim 1, wherein the sound effect expression is in XML format.

9. The method according to claim 4, wherein the sound effect expression is in text form or in the form of the combination of text and icon.

10. The method according to claim 9, wherein the step of interpreting the sound effect expression comprises: translating the icons in the sound effect expression into the corresponding textual tags; and interpreting the sound effect expression with a standard stack-based rule interpretation method.

11. The method according to claim 1, wherein to determine the operations corresponding to respective sound effect tags comprises: to determine the sound effect objects corresponding to respective sound effect tags, and further to determine the operations on respective sound effect objects and the sound objects on which respective sound effect actions are operated.

12. A system for generating sound effects interactively, comprising:
a sound effect tag provider for providing a plurality of sound effect tags to a user, wherein each of the plurality of sound effects corresponds to a specific sound effect object, the sound effect object includes a seed sound representing a predefined audio file and a sound effect action representing an operation on sound;
a sound effect tag selector for selecting at least one of the plurality of sound effect tags for a whole source sound or at least a piece of the source sound by the user;
a sound effect editor for editing the source sound by using the selected sound effect tags to form a sound effect expression;
a sound effect interpreter for interpreting the sound effect expression to determine the operations corresponding to respective sound effect tags in the sound effect expression and the execution order of the operations; and
a sound effect engine for executing the operations in said order to output a sound with the sound effects.

13. The system according to claim 12, further comprising a sound effect tag generator for linking a specific tag with a specific sound effect object to form a sound effect tag.

14. The system according to claim 13, wherein the sound effect tag generator further comprises a sound effect setting interface for defining sound effect tags by the user.

15. The system according to claim 14, wherein the sound effect provider further comprises a sound effect tag library for storing system-predefined sound effect tags and/or user-defined sound effect tags.

16. The system according to claim 12, wherein the source sound is any one of a prerecorded sound or a real-time sound or a sound synthesized by text-to-speech.

17. The system according to claim 12, wherein the sound effect editor is an XML editor, by which a sound effect expression in XML format is formed.

18. The system according to claim 12, wherein the sound effect editor is an editor capable of editing texts and icons, by which a sound effect expression with the combination of text and icon is formed.

19. The system according to claim 18, wherein the sound effect interpreter translates the icons in the sound effect expression into the corresponding textual tags, and employs a standard stack-based rule interpretation method to interpret the sound effect expression with the combination of text and icon; and wherein to determine the operations corresponding to respective sound effect tags comprises: to determine the sound effect objects corresponding to respective sound effect tags, and further to determine the operations on respective seed sounds and the sound objects on which respective sound effect actions are operated.

20. The system according to claim 12, wherein the sound effect engine comprises:
an inserting module for performing the inserting operation;
a mixing module for performing the mixing operation;
an echoing module for performing the echoing operation; and
a distorting module for performing the distorting operation.
